(19) United States
(12) Patent Application Publication
(10) Pub. No.: US 2026/0111666 A1
(43) Pub. Date: Apr. 23, 2026

(54) Automatic Mojibake Correction in a Storage System Management Application

(71) Applicant: Dell Products, L.P., Hopkinton, MA (US)

(72) Inventors: Aaron Twohig, Rathpeacon (IE); Emma Brennan, Bandon (IE); James Walsh, Ballincollig (IE)

(21) Appl. No.: 18/919,550

(22) Filed: Oct. 18, 2024

(51) Int. Cl. G06F 40/274; G06F 40/242

(52) U.S. Cl. CPC G06F 40/274; G06F 40/242

(57) ABSTRACT

A mojibake detection and correction engine implements mojibake detection and, where mojibake is detected, implements up to three levels of mojibake correction to restore the mojibake to the original text. When characters are read from storage, the byte values of the characters are compared with a list of ranges of byte values corresponding to characters of the particular language being used to display the characters. When one or more of the characters is outside the expected ranges, a text encoding mismatch is identified that indicates the possible presence of mojibake. The mojibake correction engine uses a three level mojibake correction, including reverse byte mapping, predictive mojibake character replacement, and replacement of known mistranslations, to restore original text from the mojibake.

### FIELD

This disclosure relates to computing systems and related devices and methods, and, more particularly, to a method and apparatus for automatic mojibake correction in a storage system management application.

### SUMMARY

The following Summary and the Abstract set forth at the end of this document are provided herein to introduce some concepts discussed in the Detailed Description below. The Summary and Abstract sections are not comprehensive and are not intended to delineate the scope of protectable subject matter, which is set forth by the claims presented below.

All examples and features mentioned below can be combined in any technically possible way.

A storage system management application enables users to customize graphical user interface displays that are generated in connection with execution of the storage system management application. Text that is entered into the user interface to describe the customized displays is stored in memory while the storage system management application is executing. When the storage system management application is upgraded or otherwise shut down, the user-generated text is persisted to storage. In some instances, persisting the user-generated text to storage will cause the original text to be encoded using an encoding scheme other than an encoding scheme used by the storage system management application, which can result in creation of mojibake when the storage system management application is subsequently restarted. Additionally, since the original text is hence lost, the original text is not available to be used to restore the mojibake.

According to some embodiments, a mojibake detection and correction engine is provided that implements mojibake detection and, where mojibake is detected, implements up to three levels of mojibake correction to restore the mojibake to the original text. In some embodiments, when characters are read from storage, the byte values are compared with a list of ranges of byte values corresponding to characters of the particular language being used to display the characters. In response to a determination that a byte value of one or more of the characters is outside a range of byte values that is used to display characters of the selected language, a text encoding mismatch is identified. Based on the text encoding mismatch, a first level of mojibake correction includes a reverse byte mapping to attempt to reverse the text encoding mismatch. In instances where the first level of mojibake correction does not remove all mojibake, a second level of mojibake correction is then implemented which implements a character-based replacement of mojibake characters with predicted characters based on surrounding characters and a mojibake character prediction table. A third level of mojibake correction is then implemented by searching the corrected text for any known mistranslations, and replacing any identified known mistranslations with corrected translations. By implementing a mojibake detection and correction system to correct mojibake, it is possible to restore characters of a string that has been misinterpreted when the original bytes are not available.

In some embodiments, a method of mojibake detection and correction, includes reading a string of characters from storage, detecting mojibake characters in the string of characters, and determining a character text encoding mismatch between two text encoding standards that caused the mojibake characters in the string of characters. The method further includes implementing a reverse byte mapping process using the two text encoding standards as a first level of mojibake correction on the string of characters, after implementing the reverse byte mapping process, determining remaining mojibake characters in the string of characters and implementing a character prediction mojibake correction process to replace each of the remaining mojibake characters in the string of characters with a respective predictive corrected character, and after implementing the character prediction mojibake correction process, searching the string of characters for a set of known mistranslations and, in response to determination that the string of characters contains one of the known mistranslations of the set of known mistranslations, replacing the one of the known mistranslations in the string of characters with a corrected translation.

In some embodiments, detecting mojibake characters in the string of characters includes determining a respective hexadecimal value of each character in the string of characters, and comparing the respective hexadecimal value of each character with a set of ranges of hexadecimal values used to represent characters in a first of the text encoding standards.

In some embodiments, a first of the two text encoding standards is a first text encoding standard native to an application being used to read the string of characters from storage, and the second of the two text encoding standards is a second text encoding standard different from the first text encoding standard. In some embodiments, determining the character text encoding mismatch between the two text encoding standards that caused the mojibake characters in the string of characters includes reading the characters using the first text encoding standard and identifying, from the string of characters, the second text encoding standard. In some embodiments, identifying the second text encoding standard includes searching the string of characters for default mojibake characters used by the different second text encoding standards to represent unknown characters, and upon identifying a default mojibake character used by one of the different second text encoding standards, determining that the second text encoding standard is the one of the different second text encoding standards that uses the identified default mojibake character.

In some embodiments, implementing the reverse byte mapping process using the two text encoding standards includes encoding the string of characters using the second text encoding standard and decoding the string of characters using the first text encoding standard.

In some embodiments, implementing the character prediction mojibake correction process to replace each of the remaining mojibake characters in the string of characters with a respective predictive corrected character includes, for each remaining mojibake character in the string of characters identifying known characters in the string of characters adjacent to the remaining mojibake character, and using a mojibake character prediction table to predict a replacement character for the remaining mojibake character based on the identified adjacent known characters. In some embodiments, the adjacent known characters are nearest characters ahead of the remaining mojibake character and behind the remaining mojibake character in the string of characters.

In some embodiments, searching the string of characters for the set of known mistranslations includes comparing the string of characters with entries of a dictionary of known mistranslations, the dictionary of known mistranslations including a plurality of entries, each entry including a key/value pair, where the key of the key/value pair corresponds to one of the known mistranslations and the value of the key/value pair corresponds to a correct translation of the one of the known mistranslations. In some embodiments, each of the entries of the dictionary of known mistranslations are created by taking a respective original character string encoded in a first of the two text encoding standards, persisting the original character string to cause the original character string to be encoded using a second of the two text encoding standards, reading the persisted character string using the first of the two text encoding standards, detecting mojibake characters in the persisted character string, implementing the reverse byte mapping mojibake correction process and the character prediction mojibake correction process on the read persisted character string to create a respective mojibake corrected character string, and comparing the respective mojibake corrected character string with the respective original character string, and, in response to determination that the respective mojibake corrected character string does not match the respective original character string, creating a respective entry in the dictionary of known mistranslations in which the respective mojibake corrected character string is the key of the respective entry and the respective original character string is the value of the respective entry.

### BRIEF DESCRIPTION OF THE DRAWINGS

FIG. 1 is a functional block diagram of a host computer connected to an example storage system, including a storage system management application executing on the host computer and a storage system configurator executing on the storage system to implement management operations of the management application on the storage system, according to some embodiments.

FIG. 2 is a block diagram of a storage system management application containing a mojibake detection and correction engine, according to some embodiments.

FIG. 3 is a flow chart of an example process of mojibake detection and correction in a storage system management application, according to some embodiments.

FIG. 4 is a flow chart of an example process of creating a set of known mistranslations for use in an example mojibake detection and correction engine, according to some embodiments.

FIG. 5 is an example graphical user interface of an example storage system management application showing example user-added Japanese text prior to storage of the user-added Japanese text to external storage in connection with a restart or upgrade of the storage system management application, according to some embodiments.

FIG. 6 is the example graphical user interface of the example storage system management application of FIG. 5, showing the user-added Japanese text converted to mojibake after the user-added Japanese text was retrieved from external storage after the restart or upgrade of the storage system management application, according to some embodiments.

FIGS. 7A-7C show several examples of how particular text strings can be altered when the text is originally encoded using UTF8 and is subsequently stored in external storage using CP1252 encoding, and then using UTF8 to subsequently create characters from the persisted bytes, according to some embodiments.

FIG. 8 shows operation of an example mojibake detection and correction engine configured to implement three levels of mojibake correction to correct mojibake that can be generated when storing example Japanese language user-generated text using a different encoding scheme, according to some embodiments.

FIGS. 9A and 9B are tables showing examples of mojibake that can be created when text that is originally encoded using UTF8 is subsequently encoded using Windows31J for storage (FIG. 9A) or CP1252 (FIG. 9B). FIGS. 9A and 9B also show example corrections of the generated mojibake by a mojibake detection and correction engine configured to implement a three level mojibake correction process, according to some embodiments.

FIG. 10 shows operation of an example mojibake detection and correction engine configured to implement three levels of mojibake correction to correct mojibake that can be generated when storing example Hebrew language user-generated text using a different encoding scheme, according to some embodiments.

### DETAILED DESCRIPTION

Aspects of the inventive concepts will be described as being implemented in a storage system 100 connected to a host computer 102. Such implementations should not be viewed as limiting. Those of ordinary skill in the art will recognize that there are a wide variety of implementations of the inventive concepts in view of the teachings of the present disclosure.

Some aspects, features and implementations described herein may include machines such as computers, electronic components, optical components, and processes such as computer-implemented procedures and steps. It will be apparent to those of ordinary skill in the art that the computer-implemented procedures and steps may be stored as computer-executable instructions on a non-transitory tangible computer-readable storage medium. Furthermore, it will be understood by those of ordinary skill in the art that the computer-executable instructions may be executed on a variety of tangible processor devices, i.e., physical hardware. For ease of exposition, not every step, device or component that may be part of a computer or data storage system is described herein. Those of ordinary skill in the art will recognize such steps, devices, and components in view of the teachings of the present disclosure and the knowledge generally available to those of ordinary skill in the art. The corresponding machines and processes are therefore enabled and within the scope of the disclosure.

The terminology used in this disclosure is intended to be interpreted broadly within the limits of subject matter eligibility. The terms “logical” and “virtual” are used to refer to features that are abstractions of other features, e.g., and without limitation, abstractions of tangible features. The term “physical” is used to refer to tangible features, including but not limited to electronic hardware. For example, multiple virtual computing devices could operate simultaneously on one physical computing device. The term “logic” is used to refer to special purpose physical circuit elements, firmware, and/or software implemented by computer instructions that are stored on a non-transitory tangible computer-readable storage medium and implemented by multi-purpose tangible processors, and any combinations thereof.

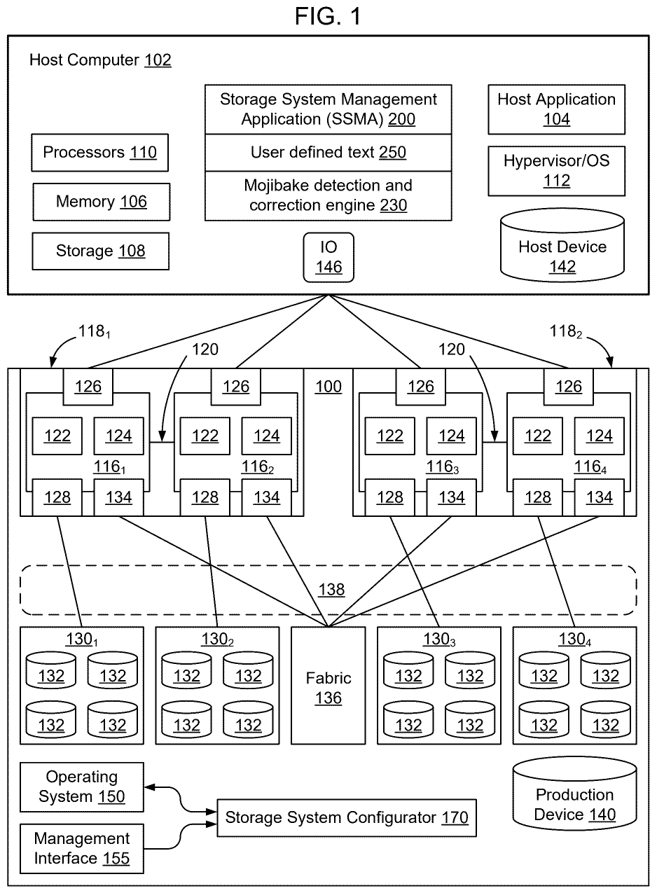

FIG. 1 illustrates a storage system 100 and an associated host computer 102, of which there may be many. The storage system 100 provides data storage services for a host application 104, of which there may be more than one instance and type running on the host computer 102. In the illustrated example, the host computer 102 is a server with host volatile memory 106, persistent storage 108, one or more tangible processors 110, and a hypervisor or OS (Operating System) 112. The processors 110 may include one or more multi-core processors that include multiple CPUs (Central Processing Units), GPUs (Graphics Processing Units), and combinations thereof. The host volatile memory 106 may include RAM (Random Access Memory) of any type. The persistent storage 108 may include tangible persistent storage components of one or more technology types, for example and without limitation SSDs (Solid State Drives) and HDDs (Hard Disk Drives) of any type, including but not limited to SCM (Storage Class Memory), EFDs (Enterprise Flash Drives), SATA (Serial Advanced Technology Attachment) drives, and FC (Fibre Channel) drives. The host computer 102 might support multiple virtual hosts running on virtual machines or containers.

The storage system 100 includes a plurality of compute nodes 116₁-116₄, possibly including but not limited to storage servers and specially designed compute engines or storage directors for providing data storage services. In some embodiments, pairs of the compute nodes, e.g. (116₁-116₂) and (116₃-116₄), are organized as storage engines 118₁ and 118₂, respectively, for purposes of facilitating failover between compute nodes 116 within storage system 100. In some embodiments, the paired compute nodes 116 of each storage engine 118 are directly interconnected by communication links 120. As used herein, the term “storage engine” will refer to a storage engine, such as storage engines 118₁ and 118₂, which has a pair of (two independent) compute nodes, e.g. (116₁-116₂) or (116₃-116₄). A given storage engine 118 is implemented using a single physical enclosure and provides a logical separation between itself and other storage engines 118 of the storage system 100. A given storage system 100 may include one storage engine 118 or multiple storage engines 118.

Each compute node, 116₁, 116₂, 116₃, 116₄, includes processors 122 and a local volatile memory 124. The processors 122 may include a plurality of multi-core processors of one or more types, e.g., including multiple CPUs, GPUs, and combinations thereof. The local volatile memory 124 may include, for example and without limitation, any type of RAM. Each compute node 116 may also include one or more front-end adapters 126 for communicating with the host computer 102. Each compute node 116₁-116₄ may also include one or more back-end adapters 128 for communicating with respective associated back-end drive arrays 130₁-130₄, thereby enabling access to managed drives 132. A given storage system 100 may include one back-end drive array 130 or multiple back-end drive arrays 130.

In some embodiments, managed drives 132 are storage resources dedicated to providing data storage to storage system 100 or are shared between a set of storage systems 100. Managed drives 132 may be implemented using numerous types of memory technologies for example and without limitation any of the SSDs and HDDs mentioned above. In some embodiments the managed drives 132 are implemented using NVM (Non-Volatile Memory) media technologies, such as NAND-based flash, or higher-performing SCM (Storage Class Memory) media technologies such as 3D XPoint and ReRAM (Resistive RAM). Managed drives 132 may be directly connected to the compute nodes 116₁-116₄, using a PCIe (Peripheral Component Interconnect Express) bus or may be connected to the compute nodes 116₁-116₄, for example, by an IB (InfiniBand) bus or fabric.

In some embodiments, each compute node 116 also includes one or more channel adapters 134 for communicating with other compute nodes 116 directly or over an interconnecting fabric 136. An example interconnecting fabric 136 may be implemented using PCIe or IB. Each compute node 116 may allocate a portion or partition of its respective local volatile memory 124 to a virtual shared memory 138 that can be accessed by any compute node 116 of storage system 100.

The storage system 100 maintains data for host applications 104 running on the host computer 102. For example, host application 104 may write data of host application 104 to the storage system 100 and read data of host application 104 from the storage system 100 in order to perform various functions. Examples of host applications 104 may include but are not limited to file servers, email servers, block servers, and databases.

Logical storage devices are created and presented to the host application 104 for storage of the host application 104 data. For example, as shown in FIG. 1, a production device 140 and a corresponding host device 142 are created to enable the storage system 100 to provide storage services to the host application 104.

The host device 142 is a local (to host computer 102) representation of the production device 140. Multiple host devices 142, associated with different host computers 102, may be local representations of the same production device 140. The host device 142 and the production device 140 are abstraction layers between the managed drives 132 and the host application 104. From the perspective of the host application 104, the host device 142 is a single data storage device having a set of contiguous fixed-size LBAs (Logical Block Addresses) on which data used by the host application 104 resides and can be stored. However, the data used by the host application 104 and the storage resources available for use by the host application 104 may actually be maintained by the compute nodes 116₁-116₄ at non-contiguous addresses (tracks) on various different managed drives 132 on storage system 100.

In some embodiments, the storage system 100 maintains metadata that indicates, among various things, mappings between the production device 140 and the locations of extents of host application data in the virtual shared memory 138 and the managed drives 132. In response to an IO (Input/Output command) 146 from the host application 104 to the host device 142, the hypervisor/OS 112 determines whether the IO 146 can be serviced by accessing the host volatile memory 106 or storage 108. If that is not possible then the IO 146 is sent to one of the compute nodes 116 to be serviced by the storage system 100.

In the case where IO 146 is a read command, the storage system 100 uses metadata to locate the commanded data, e.g., in the virtual shared memory 138 or on managed drives 132. If the commanded data is not in the virtual shared memory 138, then the data is temporarily copied into the virtual shared memory 138 from the managed drives 132 and sent to the host application 104 by the front-end adapter 126 of one of the compute nodes 116₁-116₄.

In the case where the IO 146 is a write command, in some embodiments the storage system 100 copies a block being written into the virtual shared memory 138, marks the data as dirty, and creates new metadata that maps the address of the data on the production device 140 to a location to which the block is written on the managed drives 132.

As shown in FIG. 1, storage systems are one example of a complex electrical computing system that may be configured in multiple ways to achieve multiple different types of functions. For example, the storage system 100 may be used by multiple host computers, and different configuration changes may be implemented on the storage system such as to zone aspects of the storage system for use by each of the computers, create the storage volumes, storage groups, and many other aspects of how the storage system should provide access to storage resources and protect data stored in managed drives.

According to some embodiments, as shown in FIG. 1, multiple systems may cooperate to enable the configuration of the storage system to be set and adjusted over time. For example, as shown in FIG. 1, in some embodiments a storage system configurator 170 may be implemented on the storage system 100, that receives configuration instructions and interacts with the operating system 150 of the storage system to change the configuration of the storage system. Example configuration actions might be, for example, to cause creation of storage volumes, link the storage volumes to particular devices, create storage groups of storage volumes, create storage pools of back-end storage resources to be used to implement the actual storage for the various storage volumes, and multiple other configuration related operations. In some embodiments, the storage system configurator 170 includes a management interface 155, e.g., implemented as a command line interface or graphical user interface, that enables access to the storage system configurator 170 to enable a user to take configuration actions and make configuration queries directly on the storage system 100.

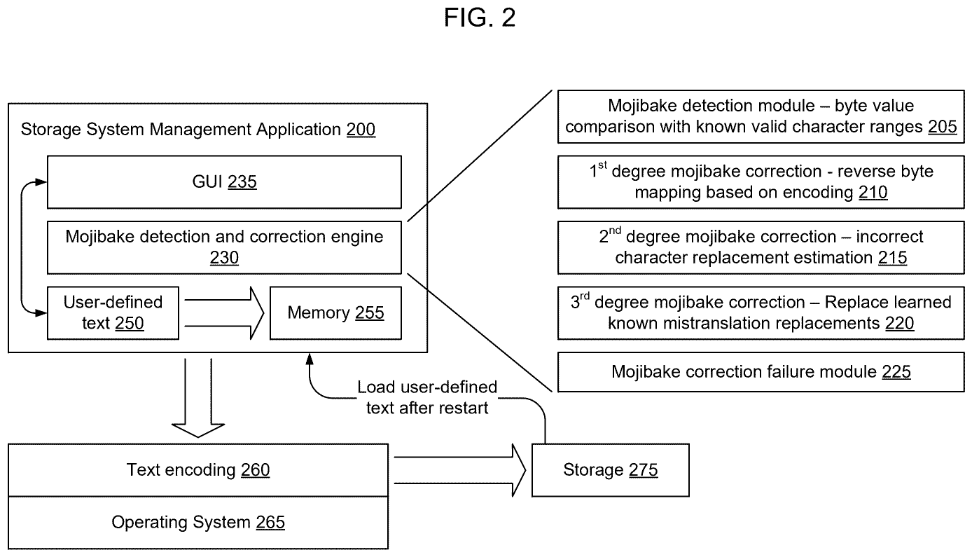

FIG. 2 is a block diagram of a storage system management application 200 containing a mojibake detection and correction engine 230, according to some embodiments. As shown in FIG. 2, in some embodiments the storage system management application 200 includes a graphical user interface 235 configured to interact with the management interface 155 of the storage system 100 to take actions on the storage system and monitor performance of the storage system. The storage system management application 200 may be run directly on the storage system 100 or may be run on host 102 or on another computer external to the storage system 100. The storage system management application 200 may be implemented, for example, as an application running on a laptop computer or as a web application that is accessible through a web portal or in another manner depending on the particular implementation.

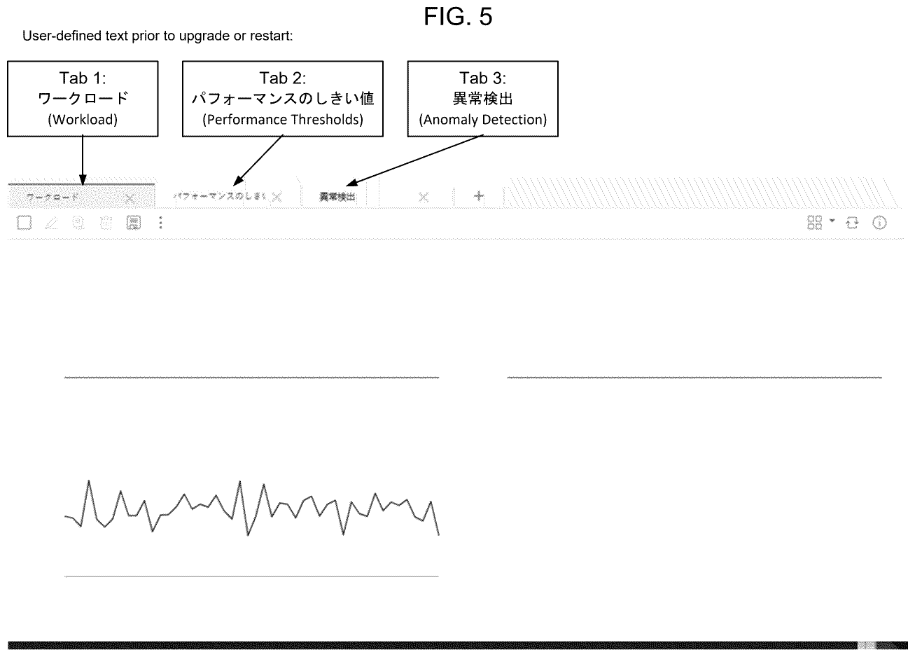

In some embodiments, the storage system management application provides a graphical user interface 235 that is presented to the user to enable the user to take actions on the storage system. In some embodiments, the user is able to customize the graphical user interface to specify aspects of the storage system performance that are of interest to the user. For example, as shown in the example shown in FIG. 5, the storage system management application might allow the user to define a screen having multiple tabs, in which each of the tabs is labeled a particular name and shows particular aspects of the performance of a single storage system or multiple storage systems. For example, in FIG. 5, the user-defined tabs include Tab 1, labeled “workload”, Tab 2, labeled “performance thresholds”, and Tab 3, labeled “anomaly detection”. Providing the user with the ability to define custom screens of the graphical user interface thus enables the user to quickly transition between aspects that are of interest to the user. For example, in some embodiments, as shown in FIG. 2, the storage system management application 200 enables the user to input user-defined text 250 that is stored in memory 255 and used to customize the GUI 235.

During an upgrade to the storage system management application 200 or in other instances, the user-defined text 250 that is stored in memory 255 will be persisted to storage 275. Persisting the user-defined text 250 to storage may require the text to be encoded, for example using a text encoding system 260 provided by the operating system 265. In instances where the text encoding system used by the storage system management application 200 is different than the encoding system 260 used by the operating system 265, when the user defined text is loaded back to the storage system management application from storage 275, there may be inconsistencies between the user-defined text that was originally entered by the user and the user-defined text that is reloaded. This is referred to herein as mojibake.

For Latin characters, many of the text encoding standards are consistent such that encoding Latin characters using one standard and decoding the characters using a different standard does not cause any difference in the appearance of the text on the graphical user interface 235. In instances where the graphical user interface is translated into languages other than English, differences in encoding schemes used by different operating systems and different types of computers can cause this user-entered text to become garbled in particular instances.

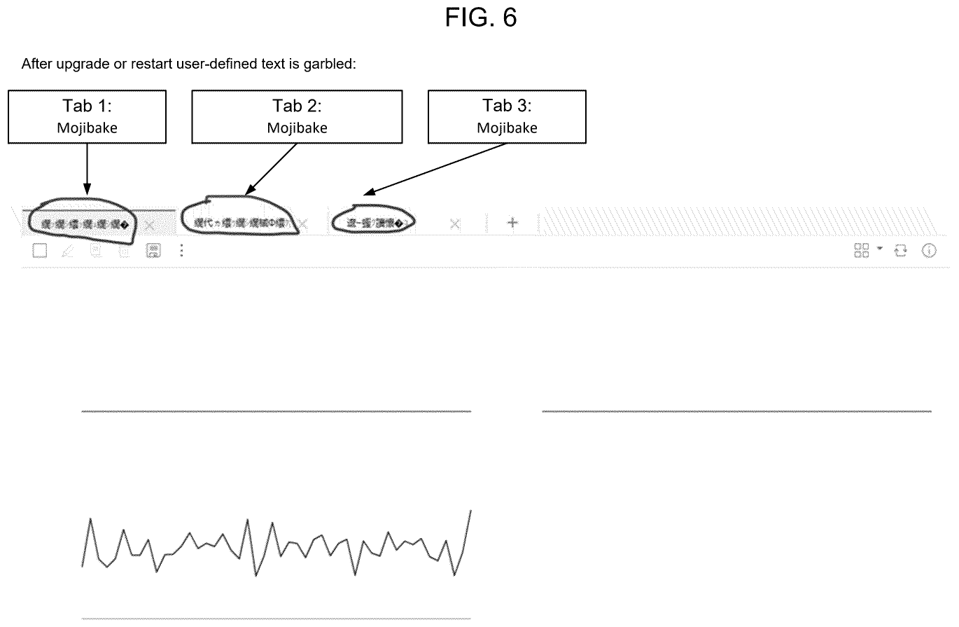

FIGS. 5 and 6 show a hypothetical example of how user-defined text may be used to create a given screen of a graphical user interface 235 (FIG. 5) and the mojibake that may be generated when the user-defined text is persisted to storage using a first encoding scheme that is inconsistent with the text encoding scheme that is used to decode the text when the user-defined text is read back from storage 275 to the storage system management application 200. As shown in FIG. 6, in some instances when the user-specified text is persisted to external storage 275, the user-specified text might be encoded using a different standard than the encoding standard used by the storage system management application. When the user-defined text is then loaded from storage 275, the difference in encoding standards can cause the user-entered text to become garbled when subsequently loaded to the storage system management application.

For example, Linux generally encodes characters using the UTF8 character encoding standard. Windows™ machines that are running a Windows™ operating system, by contrast, often encode characters using CP1252 character encoding standard. Japanese language characters are often encoded using Windows31J character encoding standard. When a user enters a set of characters into the graphical user interface of a storage system management application that is running on a Linux operating system, the characters will accordingly be encoded using the UTF8 character encoding system. If the user is accessing the storage system management application 200 using an application client that is running on a laptop that is running a Windows Operating System (“OS”), when the application client is shut down, those user-entered characters will be persisted to local storage and often will be encoded by the Windows OS using CP1252 or Windows31J. For example, when the storage system management application is shut down and restarted in connection with an upgrade process, the user-entered text that was entered in connection with customization of the user interface will be persisted to storage, and then subsequently loaded to the new version of the storage system management application. The lack of symmetry between UTF8 used by the storage system management application and the CP1252 or Windows31J used to store the user-defined text can cause the user-defined text to be garbled when reloaded from storage 275 to the new version of the storage system management application.

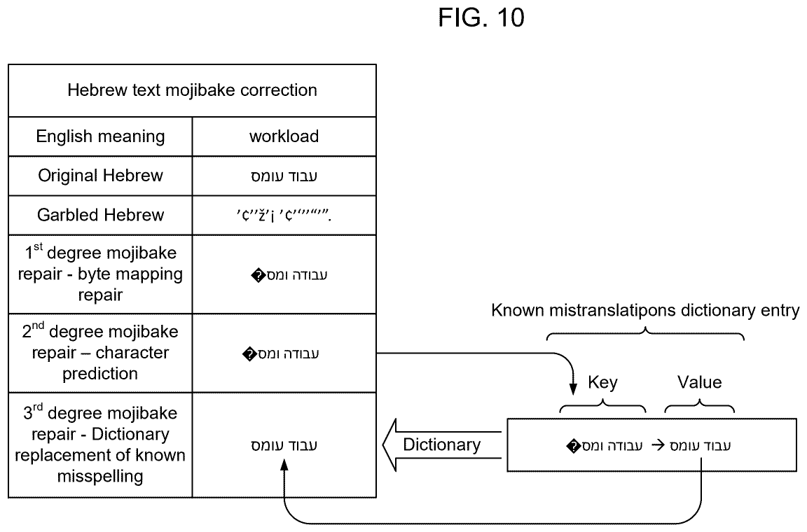

Garbled text that is created due to an encoding mismatch is referred to herein as “mojibake”. Although some embodiments are described herein in which mojibake is generated due to a mismatch between several example encoding standards relative to Japanese language characters, similar mojibake may be created in numerous other languages where the various standards do not coincide and do not use the same hexadecimal value to reference the same characters. For example, FIG. 10 shows an example of mojibake that may be created when Hebrew language text is entered into a storage system management application that uses a first encoding scheme (UTF8) and is subsequently persisted using a different encoding scheme (CP1252), and then loaded back from persistent storage to the storage system management application. Numerous other languages that use special characters, such as characters with particular accent marks, are also susceptible to creation of mojibake in connection with encoding mismatches between the various character encoding standards.

According to some embodiments, a storage system management application includes or is interfaced with a mojibake detection and correction engine 230. In some embodiments, the mojibake detection and correction engine 230 includes mojibake detection 205, three levels of mojibake correction 210, 215, 220, and includes a mojibake correction failure module 225. In some embodiments, the mojibake detection and correction engine 230 implements a mojibake detection process 205, that compares byte values of characters against a known set of byte value ranges to detect the likely presence of mojibake.

When the likelihood of mojibake is determined, the mojibake detection and correction engine 230 implements a first level of mojibake correction 210 that detects the type of encoding mismatch and uses reverse byte mapping to reverse symmetrical mismatchings between the two character encoding standards. After reversing the incorrect byte mappings, the mojibake detection and correction engine implements a second level of mojibake correction 215 in which asymmetrical differences in character encoding standards are identified and a best guess character replacement is implemented on the remaining mojibake, for example by evaluating the mojibake characters in the context of surrounding characters that have been determined to not be mojibake. After the first and second level mojibake correction, the mojibake detection and correction engine implements a third level mojibake correction process 220, in which words containing mojibake are compared with a dictionary of known misspellings. Whenever a known misspelled word is identified in the user-entered text, the mojibake detection and correction engine replaces the word containing the mojibake with the correct spelling from the dictionary. When mojibake is not able to be corrected using the three level mojibake correction process (210, 215, 220), the mojibake correction failure module replaces the mojibake with a phrase indicating that the original text was not able to be recovered. In this way, the mojibake detection and correction engine 230 is able to achieve a high level of mojibake correction to restore the original user-entered text in situations where the original user-entered text has been lost due to the character encoding mismatch between the text that was originally entered by the user and the character encoding that was used to persist the user-entered text to storage.

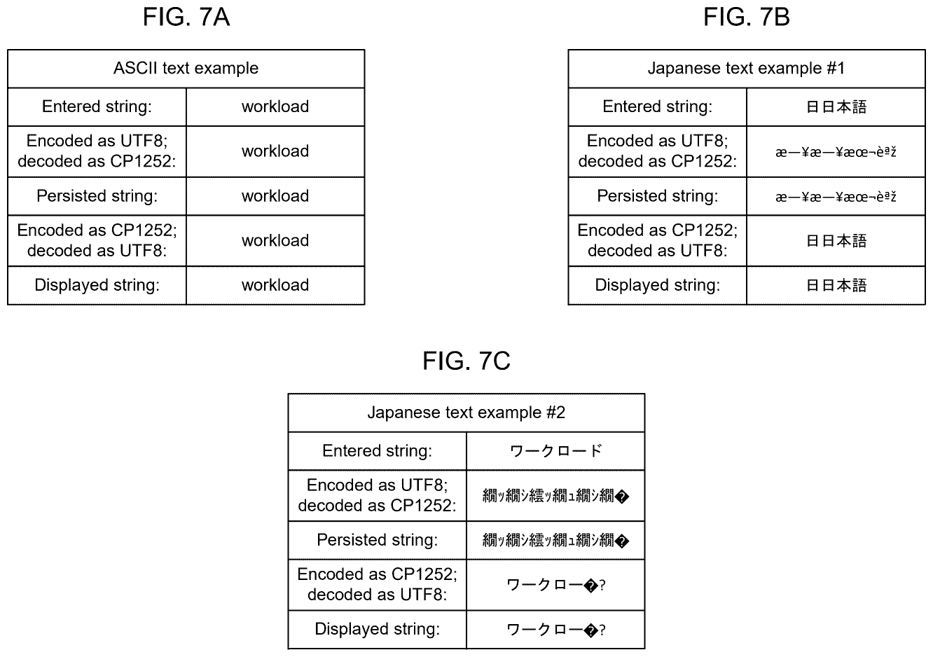

Systems may accidentally use inconsistent character encoding standards when storing, retrieving, and transferring text. The inconsistencies will often go unnoticed when using Latin characters for English language users, but become apparent in other languages such as Japanese. For example, as shown in FIG. 7A, when the ASCII text “workload” is entered in English, if the text is originally encoded as UTF8 and subsequently decoded as CP1252, there is no difference-both standards are in agreement as to the particular byte values to be used to represent each of the characters. Accordingly, when the characters of the word “workload” is originally encoded as UTF8, and then decoded as CP1252 to be stored in external storage, the string that is persisted also reads as “workload”. When the persisted string is subsequently read from storage, and encoded as UTF8, it will appear on the graphical user interface of the storage system management system in the same form as it was originally entered by the user-namely the user will see “workload”.

The same is not true for all other languages, particularly for languages that have characters that are different from Latin characters. For example, as shown in FIGS. 7B and 7C, there are some strings of characters that, when originally encoded as UTF8 and subsequently decoded as CP1252 will have a very different set of persisted characters. In FIG. 7B, when the persisted string is read back from the external storage to the storage system management application, the string of characters that will be displayed on the graphical user interface is very different than the originally entered string of characters. As shown in FIG. 7B, there are some symmetrical differences in encoding that enable the original UTF8 characters to be recreated using only a first level of mojibake correction. However, as shown in FIG. 7C, there are some asymmetrical differences in encoding standards that do not enable the original UTF8 characters to be restored. Specifically, as shown in FIG. 7C, the last character of the original encoded string is incorrect even after reverse encoding, which leads to generation of mojibake on the graphical user interface of the storage system management application.

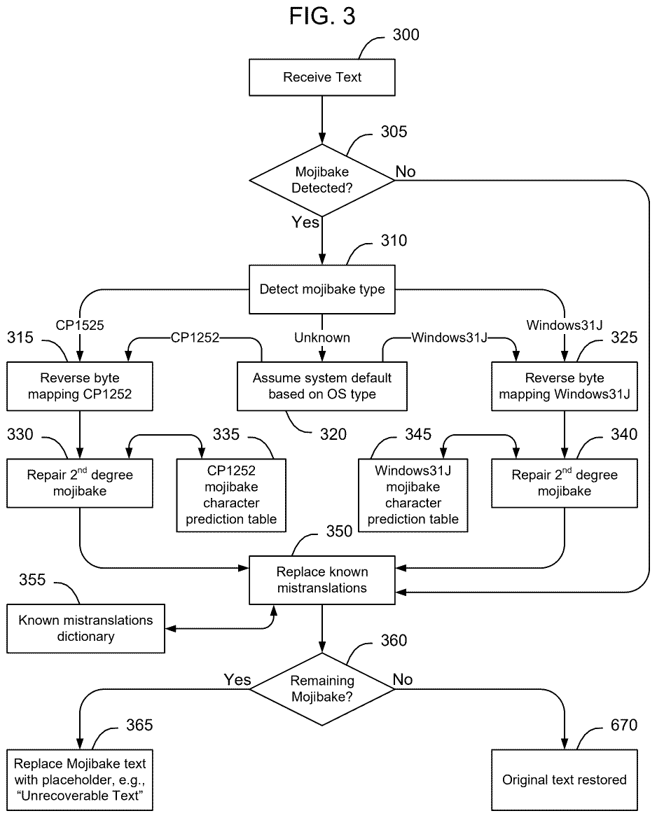

FIG. 3 is a flow chart of an example process of mojibake detection and correction in a storage system management application, according to some embodiments. As shown in FIG. 3, when text is received (block 300) the mojibake detection and correction engine 230 analyzes the text to determine if any mojibake is detected (block 305). In some embodiments, mojibake is detected by looking for characters having byte values outside of expected ranges of byte values specified by the relevant text encoding standard that was used to decode the received text.

For example, in some embodiments the text that is received is analyzed by checking if each character is a valid Latin or Japanese character using its hexadecimal value. In UTF8, Valid ASCII and Japanese characters fall within known hexadecimal ranges. ASCII has a single range: 0x0000 to 0x007f. Table I, shown below, includes ranges of hexadecimal values for Japanese characters:

TABLE I
0x30a0 to 0x30ff // Katakana (Full Width)
0x3400 to 0x4DB5 // Kanji (Han) slightly narrower than CJK unified ideographs
0x4E00 to 0x9FCB // Kanji (Han)
0xF900 to 0xFA6A // Kanji (Han)
0x2E80 to 0x2FD5 // Kanji Radicals
0xFF5F to 0xFF9F // Katakana and Punctuation (Half Width)
0x3000 to 0x303F // Japanese Symbols and Punctuation
0x31F0 to 0x31FF // Miscellaneous Japanese Symbols and Characters
0x3220 to 0x3243 // Miscellaneous Japanese Symbols and Characters
0x3280 to 0x337F // Miscellaneous Japanese Symbols and Characters
0xFF01 to 0xFF5E // Alphanumeric and Punctuation (Full Width)
0x3040 to 0x309F // Hiragana, slightly wider definition
0xff00 to Oxffef // Full-width roman characters and half-width katakana
0xff01 to 0xff5e // Selected Full-width roman characters,
0x4e00 to 0x9faf // CJK unified ideographs - Common and uncommon kanji
0x1F900 to 0x1FAFF // CJK Compatibility Ideographs - Han

By analyzing the received text to determine if any of the hexadecimal values of the characters of the received text fall outside of one or more expected hexadecimal value ranges, it is possible to determine whether the received text contains any mojibake that needs to be corrected. Specifically, in some embodiments, if the hexadecimal value of one or more of the characters of the received text is outside of the set of ranges of the encoding standard that is being used to read the text, the mojibake detection and correction engine 230 is able to determine that the one or more characters has not been decoded to a valid Japanese character. Although some embodiments are described in which the mojibake detection is based on a particular standard that is used to determine whether the received text has been decoded to a valid range of Japanese characters, similar comparisons may be used to determine mojibake for other languages that have unique characters other than ASCII characters.

In some embodiments, when mojibake is detected (a determination of YES at block 305) the mojibake detection and correction engine 230 detects the mojibake type (block 310). In some embodiments, as noted above, mojibake may be created due to a mismatch in encoding values between UTF8 and another text encoding standard such as CP1252 or Windows31J. There may be other text encoding standards as well, but because these are two commonly used text encoding standards, the description will focus primarily on detecting mojibake created due to the mismatch between UTF8 and these two standards. In some embodiments, different standards use different default characters to represent mojibake. Specifically, when byte values are encountered that do not map to any characters within a character set, a default character is used to represent all instances of those mis-matched characters. For example, CP1252 uses ( [symbol] ) whereas Windows31J uses ( [symbol] ) Accordingly, in some embodiments the mojibake detection and correction engine 230 searches for known mojibake characters at block 310. When the mojibake character ( [symbol] ) is detected, the mojibake type is identified as CP1252 and the mojibake detection and correction engine 230 implements a first level of mojibake correction by implementing a reverse byte mapping between CP1252 and UTF8 (block 315). When the mojibake character ( [symbol] ) is detected, the mojibake type is identified as Windows31J and the mojibake detection and correction engine 230 implements a first level of mojibake correction by implementing a reverse byte mapping between Windows31J and UTF8 (block 325). When no mojibake type-specific characters are detected, e.g., if neither ( [symbol] ) nor ( [symbol] ) is detected (block 320), the mojibake detection and correction engine 230 assumes that the detected mojibake was created due to a mismatch between UTF8 and the system default based on the operating system type (block 320). Accordingly, in some embodiments at block 320 the mojibake detection and correction engine 230 determines the operating system type to make a determination that either the mojibake was created due to a mismatch between UTF8 and CP1252 or due to a mismatch between UTF8 and Windows31J.

As shown in FIG. 3, in some embodiments the mojibake detection and correction engine 230 performs a first level mojibake correction (blocks 315 and 325) by encoding the mojibake string with the original character set, and then reading the byte array as UTF8. In instances where the detected mojibake is CP1252, the reverse byte mapping causes the stored characters to be encoded using CP1252 and then the byte array is read as UTF8 (block 315). In instances where the detected mojibake is Windows31J, the reverse byte mapping causes the stored characters to be encoded using Windows31J and then the byte array is read as UTF8 (block 325).

Reverse byte mapping is able to correct some mojibake, but in some instances is not able to correct all mojibake. Accordingly, as shown in FIG. 3, in some embodiments the process includes a second degree mojibake repair (blocks 330, 340). In some embodiments, the second degree mojibake repair includes replacing known second degree mojibake characters with the known or most likely original equivalent. For example, as shown in FIG. 3, in instances where the mojibake was determined to be caused by encoding UTF8 with CP1252, the second degree mojibake correction (block 330) uses a CP1252 mojibake character prediction table (block 335) that uses adjacent non-mojibake characters to predict the likely character that has been replaced by the mojibake. For example, in English, the letter “Q” is often followed by the letter “U”. In instances where the mojibake character followed the letter Q, e.g. “Q [symbol] ”, the second degree of mojibake repair at block 330 would replace the [symbol] character with “U” such that “Q [symbol] ” is corrected to “Q U”. Likewise, in instances where the mojibake was determined to be caused by encoding UTF8 with Windows31J, the second degree mojibake correction (block 330) uses a Windows31J mojibake character prediction table (block 345) that uses adjacent non-mojibake characters to predict the likely character that has been replaced by the mojibake. Accordingly, in some embodiments the second degree mojibake correction is implemented to replace mojibake characters that are determined to remain after the first degree of mojibake correction, by determining a most likely character to be substituted for the detected remaining mojibake characters.

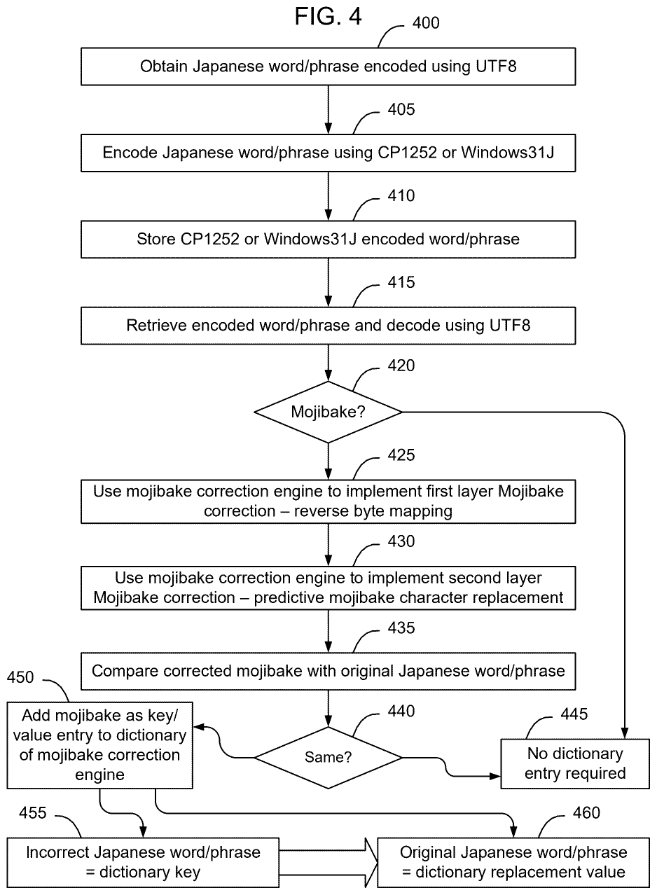

As shown in FIG. 3, after implementing first and second degree mojibake correction, the remaining byte array will include a set of characters that are all valid characters (e.g. the string will include identifiable Japanese characters and not include mojibake characters such as [symbol] or [symbol] . However, in some instances the second degree mojibake correction will cause some words to be misspelled. Accordingly, as shown in FIG. 3, in some embodiments the mojibake correction process replaces known mistranslations (block 350) using a known mistranslations dictionary (block 355). As described in greater detail in connection with FIG. 4, in some embodiments the entries in the known mistranslations dictionary are created by taking a word or phrase encoded using UTF8, storing the word using CP1252 or Windows31J to create garbled text, and then using the mojibake correction process described in connection with FIG. 3 to determine if the mojibake correction process is able to restore the original word/phrase or if the mojibake correction process creates a misspelled version of the original word/phrase. In instances where the mojibake correction process generates a misspelled version of the original word/phrase, the misspelled version of the original word/phrase and the correctly spelled version of the original word/phrase are added to the known mistranslations dictionary 355. This enables the known mistranslations dictionary 355 to be built over time to enable the mojibake detection and correction engine to evolve to learn corrections to identified mistranslations.

Accordingly, as shown in FIG. 3, in some embodiments the mojibake correction process uses a dictionary of known mistranslations 355 where the known mistranslation is the key, and the corrected phrase is the value. In some embodiments, for every key in the dictionary of known mistranslations, the mojibake correction process checks if the key is present in the target text and, if so, replaces the identified key in the target text with the associated value. In some embodiments, the dictionary of known mistranslations is externalized as a JSON, XML, comma separated file, etc., so that customers can improve the map with their own suggestions. For example, in some embodiments when mojibake appears on a graphical user interface, a user can select the mojibake word/phrase, add the mojibake word/phrase to the dictionary, and add the correct translation that should be used by the mojibake detection and correction engine 230 to correct that instance and subsequently detected instances of the mojibake word/phrase.

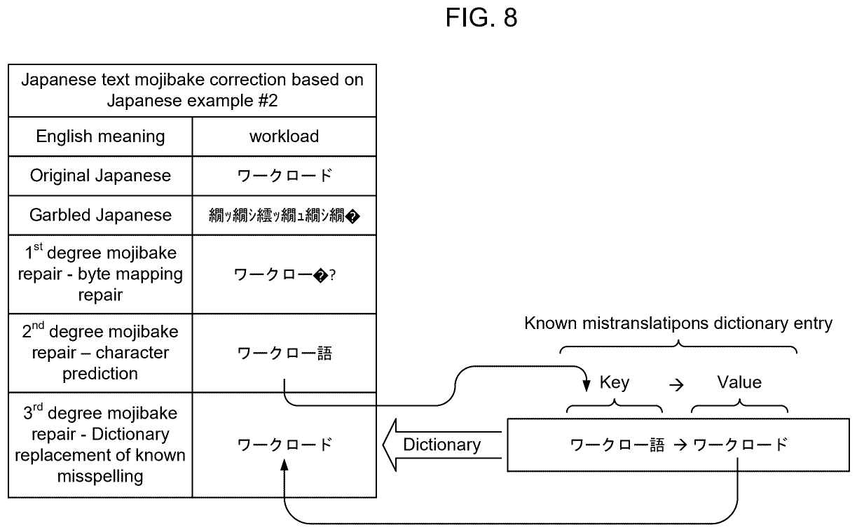

In some embodiments, the dictionary is generated from a set of Japanese strings that the management system already uses for display purposes. Many of these words and phrases are likely to be entered by users, and they are readily available in externalized files. The mistranslations of these terms can be generated by passing each string through the process that would garble it, and rescue it as far as the point of known mistranslations. For example, FIG. 8 shows the original English meaning of a Japanese word. When this Japanese word is originally encoded in UTF8, and then is persisted using the Windows31J encoding standard, the original Japanese characters become garbled. The byte mapping repair and second degree character-based prediction mojibake repair result in a misspelling of the original word. In this instance, the result of the mojibake repair process “ [symbol] [symbol] [symbol] [symbol] [symbol] [symbol] ” (the incorrect set of Japanese characters that is generated after the first and second degrees of mojibake repair) becomes a key in the dictionary of known mistranslations, and the original set of Japanese characters “ [symbol] [symbol] [symbol] [symbol] [symbol] [symbol] ” becomes the replacement value. In some embodiments, the mojibake detection and correction engine will search target text for the known mistranslation “ [symbol] [symbol] [symbol] [symbol] [symbol] [symbol] ”, and whenever that known mistranslation is detected in the target text, the mojibake detection and correction engine 230 will replace the incorrect string with “ [symbol] [symbol] [symbol] [symbol] [symbol] [symbol] ”.

As shown in FIG. 3, in some embodiments the mojibake detection and correction engine will then make a determination on whether the target text contains any remaining mojibake (block 360). In response to a determination that the target text contains remaining mojibake (a determination of YES at block 360), in some embodiments the portion of the target text that contains the remaining mojibake is replaced with a placeholder such as “unrecoverable text” (block 365). The particular phrase used will depend on the particular implementation. In response to a determination that the target text contains no remaining mojibake (a determination of NO at block 360), the original text has been restored and the mojibake correction process ends (block 370).

FIG. 4 is a flow chart of an example process of creating a set of known mistranslations for use in an example mojibake detection and correction engine, according to some embodiments. As shown in FIG. 4, in some embodiments a correctly spelled Japanese word or phrase is obtained that has been encoded to display properly in the storage system management application. For example, in embodiments where the storage system management application is built to run on the Linux operating system, a set of English words may be translated into Japanese words and phrases and encoded using the UTF8 character encoding system to be displayed in the storage system management application GUI for use in Japan or for use by individuals that would prefer to read Japanese (block 400).

According to some embodiments, a respective Japanese word/phrase that is encoded using UTF8 is encoded using CP1252 or Windows31J (block 405) to create garbled Japanese text (block 405). The garbled Japanese text is persisted to storage (block 410). The stored text is then retrieved and decoded using UTF8 (block 415), and a determination is made as to whether the retrieved text contains any mojibake (block 420). In some embodiments, the determination as to whether the retrieved text contains any mojibake comprises comparing the text that is retrieved at block 415 with the original text from block 400.

In response to a determination that no mojibake is present (a determination of NO at block 420), no entry is required in the dictionary of known mistranslations for that particular Japanese word/phrase. In response to a determination that mojibake is present (a determination of YES at block 420), the mojibake detection and correction engine implements a first layer of mojibake correction (block 425, which is described in FIG. 3 in connection with block 315/block 325), and implements a second degree of mojibake repair (block 430, which is described in FIG. 3 in connection with block 330/block 340).

After implementing the first and second layers of the mojibake repair process described in FIG. 3 that is used by the mojibake detection and correction engine 230, the corrected text is compared with the original Japanese word/phrase (block 435) to see if the corrected text is the same as the original Japanese word/phrase. If the corrected text is the same as the original Japanese word/phase (in response to a determination of YES at block 440), no dictionary entry is required (block 455) because the mojibake repair process described in FIG. 3, that is used by the mojibake detection and correction engine 230, is now known to correctly restore the garbled Japanese text that contained mojibake to match the original Japanese word/phrase.

If the corrected text is not the same as the original Japanese word/phase (in response to a determination of NO at block 440), a dictionary entry is required in the known mistranslations dictionary for use at block 355 of FIG. 3. Specifically, by causing the original Japanese text to be garbled (block 405), and then using the mojibake detection and correction engine 230 to use the first two phases of mojibake correction to attempt to repair the garbled text using the process described in FIG. 3, it is possible to identify the known mistranslation of the original Japanese word/text that will be output by the mojibake detection and correction engine 230. In some embodiments, the known mistranslation is added to the known mistranslations dictionary 355 as an entry (block 450), where the incorrect Japanese word/phrase is the dictionary key (block 455) and the original Japanese word/phrase is the dictionary replacement value (block 460).

By using the process shown in FIG. 4 with a set of words that are commonly used to implement the GUI of the storage system management application, it is possible to generate a dictionary of known mistranslations (block 355) that can subsequently be used by the mojibake detection and correction engine 230 to correct mojibake that is generated due to user customization of the user interface. Additionally, in some embodiments, whenever a user enters a word/phrase into the storage system management application to customize the user interface, the user-entered word/phrase is captured and passed through the dictionary entry creation process of FIG. 4 to determine if an additional entry should be added to the dictionary of known mistranslations 355 for the user-entered Japanese word/phrase. By building the dictionary of known mistranslations over time, it is possible to increase the likelihood that the mojibake detection and correction engine will be able to correctly restore user-entered text after occurrence of an event, such as a management system upgrade, that might otherwise result in creation of garbled user input text.

FIG. 5 is an example graphical user interface of an example storage system management application showing example user-added Japanese text prior to storage of the user-added Japanese text to external storage in connection with a restart or upgrade of the storage system management application, according to some embodiments. In the example shown in FIG. 5, the user has specified the creation of three tabs: Tab 1 is labeled “Workload”, Tab 2 is labeled “Performance Thresholds”, and Tab 3 has been labeled “Anomaly Detection”. Japanese characters are used to display the captions for these user-defined tabs. In FIG. 5, the Japanese characters are originally encoded using UTF8.

FIG. 6 is the example graphical user interface of the example storage system management application of FIG. 5, showing the user-added Japanese text converted to mojibake after the user-added Japanese text was retrieved from external storage after the restart or upgrade of the storage system management application, according to some embodiments. Specifically, during particular events the user-entered text, which is normally held in memory 255, is persisted to external storage 275. In instances where the external storage is managed by an operating system other than Linux, the operating system may cause the characters to be encoded using a different text encoding standard such as CP1252 or Windows31J. When the storage system management system reads the text from storage, it will read the values of the characters from storage and, based on the byte values, generate characters to be displayed on the user interface. As shown in FIG. 6, in some instances this will result in generation of mojibake, in which the characters that are displayed on the graphical user interface do not correspond with the original characters shown in FIG. 5.

FIGS. 7A-7C show several examples how particular text strings can be altered when the text is originally encoded using UTF8 and is subsequently stored in external storage using CP1252 encoding, and then using UTF8 to subsequently create characters from the persisted bytes, according to some embodiments. As shown in FIG. 7A, where Latin characters are being used, the standards often correspond such that there is no mismatch. For example, as shown in FIG. 7A, if the string “workload” is entered, encoded as UTF8 and decoded as CP1252, the string doesn't change and continues to be displayed as “workload”. Likewise, after being persisted, if the string is encoded as CP1252 and decoded as UTF8, the displayed string is still “workload”.

As shown in FIGS. 7B and 7C, the same is not true for various strings of Japanese strings. In some instances, as shown in FIG. 7B, encoding a string of Japanese characters and then reverse encoding the string of Japanese characters, results in restoration of the original string. In other instances, as shown in FIG. 7C, when a string of Japanese characters is originally entered as UTF8, persisted as CP1252, and then encoded as CP1252 and decoded as UTF8, the reverse encoding process does not enable the originally entered string to be restored, such that the displayed string (without the mojibake detection and correction process described herein) will not look the same as the originally entered character string.

FIG. 8 shows operation of an example mojibake detection and correction engine configured to implement three levels of mojibake correction to correct mojibake that can be generated when storing example Japanese language user-generated text using a different encoding scheme, according to some embodiments. As described in greater detail above in connection with FIG. 4, in some embodiments it is possible to identify how the mojibake detection and correction engine 230 will process a known Japanese word/phrase when the Japanese word/phrase is garbled by being persisted to storage using a text encoding standard different than the original text encoding standard. Specifically, by running the Japanese word/string through the persisting process to create the garbled Japanese, and then processing the garbled Japanese using the first and second layers of mojibake correction described above in connection with FIG. 3, it is possible to determine the output of the second degree mojibake repair. In instances where the string of Japanese characters created by processing the garbled Japanese text using the mojibake detection and correction engine is not the same as the original Japanese word/phrase, a dictionary entry is created for this known mistranslation that is added to the dictionary of known mistranslations (block 355) and used by the mojibake detection and correction engine 230 at the third level of mojibake correction (FIG. 3 block 350).

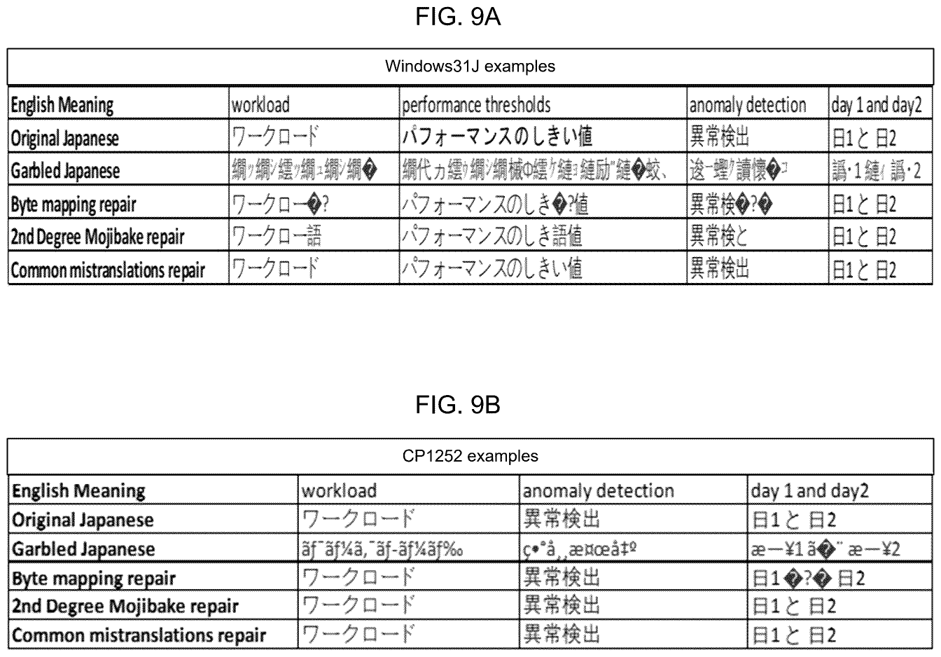

FIGS. 9A and 9B are tables showing examples of mojibake that can be created when text that is originally encoded using UTF8 is subsequently encoded using Windows31J for storage (FIG. 9A) or CP1252 (FIG. 9B). FIGS. 9A and 9B also show example corrections of the generated mojibake by a mojibake detection and correction engine 230 configured to implement a three level mojibake correction process, according to some embodiments. As shown in FIG. 9A, the original Japanese text for “workload”, “performance thresholds”, and “anomaly detection” all result in differences between the original text and the second degree of mojibake repair, and accordingly all three of these phrases require a dictionary entry to enable the mojibake detection and correction engine 230 to implement mojibake repair at the third layer, where common mistranslations are repaired. The Japanese phrase for “day 1 and day 2”, by contrast, is able to be restored from garbled Japanese to the original text simply by the first layer of mojibake repair, namely by using reverse encoding byte mapping repair by the mojibake detection and correction engine 230.

As shown in FIG. 9B, unlike the Windows31J examples of FIG. 9A, when the Japanese characters for “workload” and “anomaly detection” are originally coded using UTF8, and then are persisted as CP1252 to create garbled Japanese text, it is possible to restore the original Japanese characters from the garbled Japanese simply by the first layer of mojibake repair, namely by using reverse encoding byte mapping repair by the mojibake detection and correction engine 230. The Japanese characters for the phrase “day 1 and day 2”, in this example, requires a second degree mojibake repair by the mojibake detection and correction engine 230 before the original Japanese characters can be restored.

FIG. 10 shows operation of an example mojibake detection and correction engine configured to implement three levels of mojibake correction to correct mojibake that can be generated when storing example Hebrew language user-generated text using a different encoding scheme, according to some embodiments. FIG. 10 is similar to FIG. 8, and shows creation of a dictionary entry for a known mistranslation by passing a set of Hebrew characters representing the English word “workload” through a storage process that causes the original Hebrew characters to become garbled, and then using a mojibake detection and correction process to implement first and second degree mojibake correction to determine a known mistranslation for the originally entered word/phrase. Accordingly, although some embodiments have been described in which the mojibake detection and correction engine 230 is configured to process Japanese characters and to detect and correct Japanese mojibake, it should be understood that a similar process can be used to detect and correct mojibake that is generated due to text encoding differences with other language specific characters.

The methods described herein may be implemented as software configured to be executed in control logic such as contained in a CPU (Central Processing Unit) or GPU (Graphics Processing Unit) of an electronic device such as a computer. In particular, the functions described herein may be implemented as sets of program instructions stored on a non-transitory tangible computer readable storage medium. The program instructions may be implemented utilizing programming techniques known to those of ordinary skill in the art. Program instructions may be stored in a computer readable memory within the computer or loaded onto the computer and executed on computer's microprocessor. However, it will be apparent to a skilled artisan that all logic described herein can be embodied using discrete components, integrated circuitry, programmable logic used in conjunction with a programmable logic device such as a FPGA (Field Programmable Gate Array) or microprocessor, or any other device including any combination thereof. Programmable logic can be fixed temporarily or permanently in a tangible non-transitory computer readable medium such as random-access memory, a computer memory, a disk drive, or other storage medium. All such embodiments are intended to fall within the scope of the present invention.

Throughout the entirety of the present disclosure, use of the articles “a” or “an” to modify a noun may be understood to be used for convenience and to include one, or more than one of the modified noun, unless otherwise specifically stated. The term “about” is used to indicate that a value includes the standard level of error for the device or method being employed to determine the value. The use of the term “or” in the claims is used to mean “and/or” unless explicitly indicated to refer to alternatives only or the alternatives are mutually exclusive, although the disclosure supports a definition that refers to only alternatives and to “and/or.” The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and also covers other unlisted steps.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Various changes and modifications of the embodiments shown in the drawings and described in the specification may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

1. A method of mojibake detection and correction, comprising:
reading a string of characters from storage;
detecting mojibake characters in the string of characters;
determining a character text encoding mismatch between two text encoding standards that caused the mojibake characters in the string of characters;
implementing a reverse byte mapping process using the two text encoding standards as a first level of mojibake correction on the string of characters;
after implementing the reverse byte mapping process, determining remaining mojibake characters in the string of characters and implementing a character prediction mojibake correction process to replace each of the remaining mojibake characters in the string of characters with a respective predictive corrected character; and
after implementing the character prediction mojibake correction process, searching the string of characters for a set of known mistranslations and, in response to determination that the string of characters contains one of the known mistranslations of the set of known mistranslations, replacing the one of the known mistranslations in the string of characters with a corrected translation.

2. The method of claim 1, wherein detecting mojibake characters in the string of characters comprises determining a respective hexadecimal value of each character in the string of characters, and comparing the respective hexadecimal value of each character with a set of ranges of hexadecimal values used to represent characters in a first of the text encoding standards.

3. The method of claim 1, wherein a first of the two text encoding standards is a first text encoding standard native to an application being used to read the string of characters from storage, and the second of the two text encoding standards is a second text encoding standard different from the first text encoding standard.

4. The method of claim 3, wherein determining the character text encoding mismatch between the two text encoding standards that caused the mojibake characters in the string of characters comprises reading the characters using the first text encoding standard and identifying, from the string of characters, the second text encoding standard.

5. The method of claim 4, wherein identifying the second text encoding standard comprises searching the string of characters for default mojibake characters used by the different second text encoding standards to represent unknown characters, and upon identifying a default mojibake character used by one of the different second text encoding standards, determining that the second text encoding standard is the one of the different second text encoding standards that uses the identified default mojibake character.

6. The method of claim 1, wherein implementing the reverse byte mapping process using the two text encoding standards comprises encoding the string of characters using the second text encoding standard and decoding the string of characters using the first text encoding standard.

7. The method of claim 1, wherein implementing the character prediction mojibake correction process to replace each of the remaining mojibake characters in the string of characters with a respective predictive corrected character comprises, for each remaining mojibake character in the string of characters:
identifying known characters in the string of characters adjacent to the remaining mojibake character, and using a mojibake character prediction table to predict a replacement character for the remaining mojibake character based on the identified adjacent known characters.

8. The method of claim 7, wherein the adjacent known characters are nearest characters ahead of the remaining mojibake character and behind the remaining mojibake character in the string of characters.

9. The method of claim 1, wherein searching the string of characters for the set of known mistranslations comprises comparing the string of characters with entries of a dictionary of known mistranslations, the dictionary of known mistranslations including a plurality of entries, each entry including a key/value pair, where the key of the key/value pair corresponds to one of the known mistranslations and the value of the key/value pair corresponds to a correct translation of the one of the known mistranslations.

10. The method of claim 9, wherein each of the entries of the dictionary of known mistranslations are created by taking a respective original character string encoded in a first of the two text encoding standards, persisting the original character string to cause the original character string to be encoded using a second of the two text encoding standards, reading the persisted character string using the first of the two text encoding standards, detecting mojibake characters in the persisted character string, implementing the reverse byte mapping mojibake correction process and the character prediction mojibake correction process on the read persisted character string to create a respective mojibake corrected character string, and comparing the respective mojibake corrected character string with the respective original character string, and, in response to determination that the respective mojibake corrected character string does not match the respective original character string, creating a respective entry in the dictionary of known mistranslations in which the respective mojibake corrected character string is the key of the respective entry and the respective original character string is the value of the respective entry.

11. A mojibake detection and correction engine, comprising:
one or more processors and one or more storage devices storing instructions that are configured, when executed by the one or more processors, to cause the one or more processors to perform operations comprising:
reading a string of characters from storage;
detecting mojibake characters in the string of characters;
determining a character text encoding mismatch between two text encoding standards that caused the mojibake characters in the string of characters;
implementing a reverse byte mapping process using the two text encoding standards as a first level of mojibake correction on the string of characters;
after implementing the reverse byte mapping process, determining remaining mojibake characters in the string of characters and implementing a character prediction mojibake correction process to replace each of the remaining mojibake characters in the string of characters with a respective predictive corrected character; and
after implementing the character prediction mojibake correction process, searching the string of characters for a set of known mistranslations and, in response to determination that the string of characters contains one of the known mistranslations of the set of known mistranslations, replacing the one of the known mistranslations in the string of characters with a corrected translation.

12. The mojibake detection and correction engine of claim 11, wherein detecting mojibake characters in the string of characters comprises determining a respective hexadecimal value of each character in the string of characters, and comparing the respective hexadecimal value of each character with a set of ranges of hexadecimal values used to represent characters in a first of the text encoding standards.

13. The mojibake detection and correction engine of claim 11, wherein a first of the two text encoding standards is a first text encoding standard native to an application being used to read the string of characters from storage, and the second of the two text encoding standards is a second text encoding standard different from the first text encoding standard.

14. The mojibake detection and correction engine of claim 13, wherein determining the character text encoding mismatch between the two text encoding standards that caused the mojibake characters in the string of characters comprises reading the characters using the first text encoding standard and identifying, from the string of characters, the second text encoding standard.

15. The mojibake detection and correction engine of claim 14, wherein identifying the second text encoding standard comprises searching the string of characters for default mojibake characters used by the different second text encoding standards to represent unknown characters, and upon identifying a default mojibake character used by one of the different second text encoding standards, determining that the second text encoding standard is the one of the different second text encoding standards that uses the identified default mojibake character.

16. The mojibake detection and correction engine of claim 11, wherein implementing the reverse byte mapping process using the two text encoding standards comprises encoding the string of characters using the second text encoding standard and decoding the string of characters using the first text encoding standard.

17. The mojibake detection and correction engine of claim 11, wherein implementing the character prediction mojibake correction process to replace each of the remaining mojibake characters in the string of characters with a respective predictive corrected character comprises, for each remaining mojibake character in the string of characters:
identifying known characters in the string of characters adjacent to the remaining mojibake character, and using a mojibake character prediction table to predict a replacement character for the remaining mojibake character based on the identified adjacent known characters.

18. The mojibake detection and correction engine of claim 17, wherein the adjacent known characters are nearest characters ahead of the remaining mojibake character and behind the remaining mojibake character in the string of characters.

19. The mojibake detection and correction engine of claim 11, wherein searching the string of characters for the set of known mistranslations comprises comparing the string of characters with entries of a dictionary of known mistranslations, the dictionary of known mistranslations including a plurality of entries, each entry including a key/value pair, where the key of the key/value pair corresponds to one of the known mistranslations and the value of the key/value pair corresponds to a correct translation of the one of the known mistranslations.

20. The mojibake detection and correction engine of claim 19, wherein each of the entries of the dictionary of known mistranslations are created by taking a respective original character string encoded in a first of the two text encoding standards, persisting the original character string to cause the original character string to be encoded using a second of the two text encoding standards, reading the persisted character string using the first of the two text encoding standards, detecting mojibake characters in the persisted character string, implementing the reverse byte mapping mojibake correction process and the character prediction mojibake correction process on the read persisted character string to create a respective mojibake corrected character string, and comparing the respective mojibake corrected character string with the respective original character string, and, in response to determination that the respective mojibake corrected character string does not match the respective original character string, creating a respective entry in the dictionary of known mistranslations in which the respective mojibake corrected character string is the key of the respective entry and the respective original character string is the value of the respective entry.
